(19) United States
(12) Patent Application Publication
(10) Pub. No.: US 2007/0093116 A1
(43) Pub. Date: Apr. 26, 2007

(54) Connection device for fluid containers

(76) Inventor: Tien-Tsei Tseng, Wufong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/257,983

(22) Filed: Oct. 26, 2005

(51) Int. Cl. H01R 4/24

(52) U.S. Cl. 439/406

(57) ABSTRACT

A connection device for connection with an opening of a fluid container includes a cylindrical hollow part on which an expandable member, a movable member, a rotatable member and a handle is connected in sequence. The user holds the handle and operates a wrench to rotate the rotatbale member which moves the movable member to compress the expandable member. The expandable member is expanded to firmly engage with an inner periphery of the opening of the container such that the connection device can be well positioned when in operation.

### FIELD OF THE INVENTION

The present invention relates to a connection device having an expandable member which is expanded to seal the opening of the container when introducing pressurized air into the container.

### BACKGROUND OF THE INVENTION

A conventional inspection device for checking leakage of a fluid container such as a radiator of vehicles is shown in FIG. 6 and generally includes a base 7 which is to be connected with an opening of the radiator and a plate 71 is connected to a top of the base 7. A hollow shaft 8 extends through the plate 71 and the base 7, and includes a head 81 and a connection end 82. The head 81 has a threaded section 811 and a knob 83 is connected to the threaded section 811. A valve 9 is connected to be the connection end 82 and includes a pipe 91 and a control lever. When inspection leakage of the radiator, the user holds the pipe 91 and the knob 83 by his or her hands, the pipe 91 is rotated clockwise to connect the pipe 9 with the connection end 82, and the knob 83 is rotated clockwise to guide the hollow shat 8 move axially by the threaded section 811. This applies an axial force to the base 7 via the head 81 and the plate 71, and the base 7 is expanded so as to be engaged with the opening of the radiator. Pressurized air is then introduced into the radiator to inspect the radiator.

When rotating the knob 83 clockwise, the friction between the threaded section 811 of the hollow shaft 8 and the knob 83 often drives the pipe 91 counter clockwise relative to the hollow shaft 8, so that the pressurized air might leak from the opening of the radiator and which affects the inspection. Besides, the valve 9 and the head 82 have to be rotated in the same direction because of the threaded connection, this takes a lot of assembling time.

The present invention intends to provide a connection device for connection with the opening of a fluid container such as a vehicle radiator. The device includes an expandable member which can be squeezed to expand to seal the opening of the radiator.

### SUMMARY OF THE INVENTION

The present invention relates to a connection device which includes a cylindrical hollow part having a first end and a second end which has a first stop part. A passage is defined axially through the cylindrical hollow part and enclosed by an inner periphery of the passage. A threaded section is defined in the outer periphery of the cylindrical hollow shaft and close to the first end. A smooth section is defined between the threaded section and the second end of the cylindrical hollow part. A polygonal first connection section is located between the threaded section and the first end. An expandable member has a through hole through which the cylindrical hollow part extends. One of two end surfaces of the expandable member contacts the first stop part. A movable member is mounted on the outer periphery of the cylindrical hollow part and includes a first flange and a second flange which is in contact with the other end surface of the expandable member. A rotatable member is threadedly connected with the threaded section of the cylindrical hollow part so as to be rotated and push the movable member to compress the expandable member. A handle has a polygonal second connection section which includes a polygonal recess for being engaged with the polygonal first connection section.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the connection device of the present invention;

FIG. 2 shows that a handle is to be connected to the connection device of the present invention;

FIG. 3 is a cross sectional view to show the connection device of the present invention;

FIG. 4 shows a wrench is used to drive the rotatable member of the connection device of the present invention;

FIG. 5 is a cross sectional view to show that the expandable member is expanded to seal the opening of the radiator, and

FIG. 6 is a cross sectional view to show a conventional connection device.

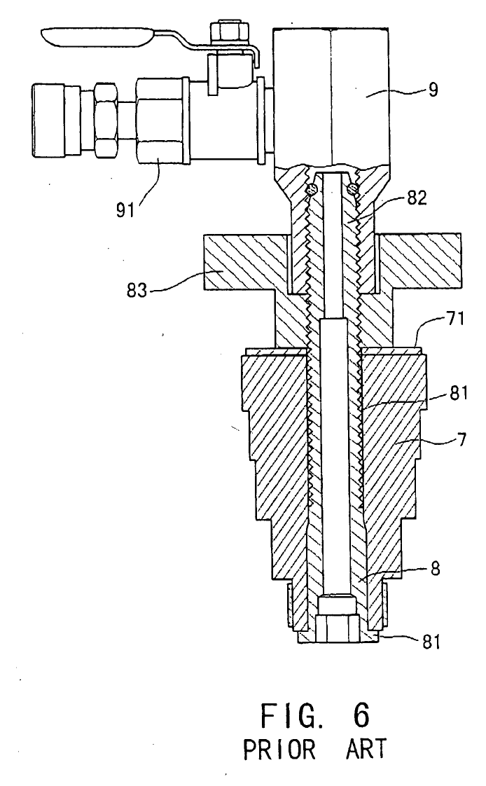

### DETAILED DESCRIPTION OF THE PREFERRED EMBODIMENT

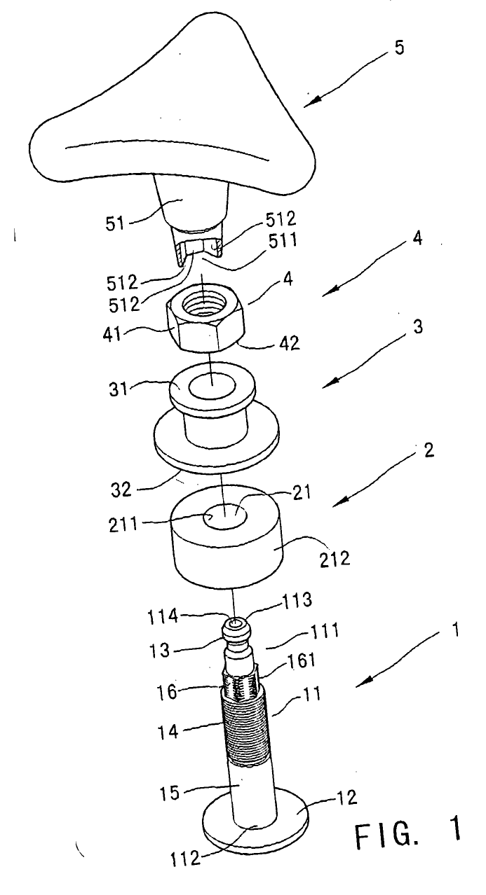

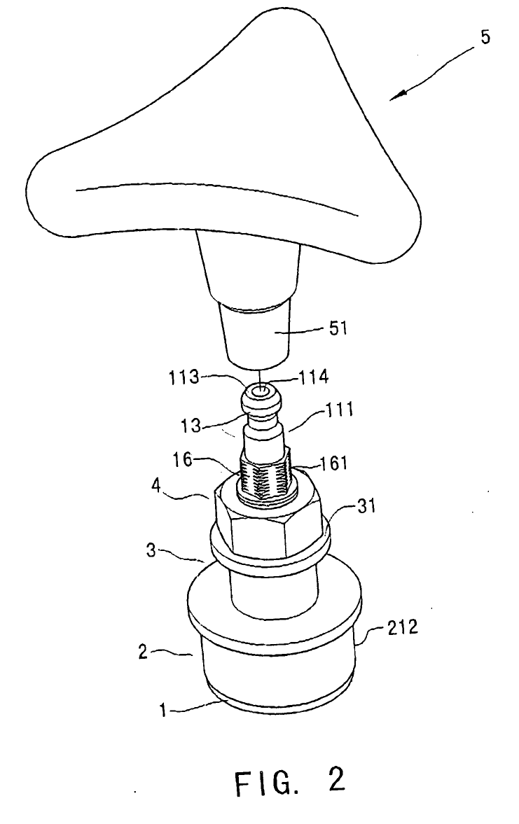

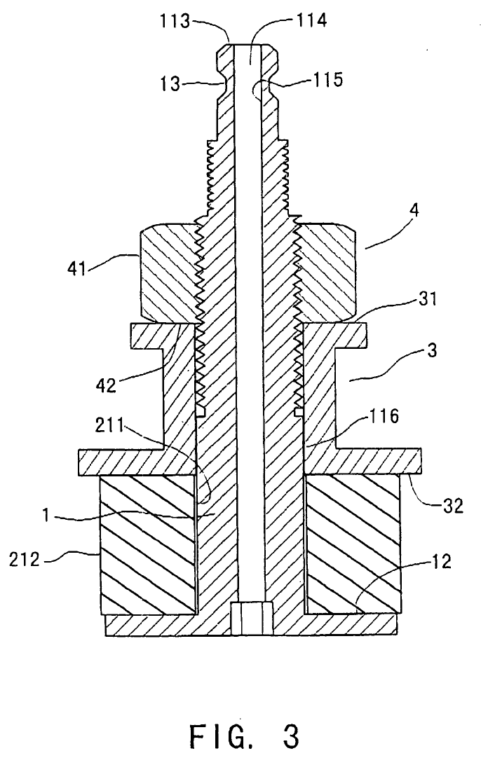

Referring to FIGS. 1 to 3, the connection device for connection with a fluid container such as a vehicle radiator of the present invention comprises a body 1 which is a cylindrical hollow part 11 which includes a first end 111 and a second end 112, wherein a first stop part 12 located on the second end 112 of the cylindrical hollow part 11. The cylindrical hollow part 11 includes a tubular body 113 between the first and second ends 111, 112, and a passage 114 is defined axially through the tubular body 113 and enclosed by an inner periphery of the passage 114. A connection end 13 such as a quick connection end is located on the first end 111 of the cylindrical hollow part 11. The tubular body 113 has an outer periphery 116 and a threaded section 14 is defined in the outer periphery 116 and close to the first end 111. A smooth section 15 is defined between the threaded section 14 and the second end 112 of the cylindrical hollow part 11. A polygonal first connection section 16 such as a hexagonal section is located between the threaded section 14 and the connection end 13. The polygonal first connection section 16 has six first surfaces 161.

An expandable member 2 is made by flexible material such as rubber and has a through hole 21 defined by an inner surface 211, and an outer periphery 212. The cylindrical hollow part 11 extends through the through hole 21 and the inner surface 211 is in contact with the outer periphery 116 of the cylindrical hollow part 11. One of two end surfaces of the expandable member 2 contacts the first stop part 12.

A movable member 3 is mounted on the outer periphery 116 of the cylindrical hollow part 11 and includes a first flange 31 and a second flange 32 which is in contact with the other end surface of the expandable member 2.

A rotatable member 4 such as a nut is threadedly connected with the threaded section 14 of the cylindrical hollow part 11 and has six driving surfaces 41 and a second stop part 42 which is in contact with the first flange 31 of the movable member 3.

A handle 5 has a polygonal second connection section 51 which includes a polygonal recess 511 having six second surfaces 512 which are matched with the first surfaces 161. The polygonal first connection section 16 is engaged with the polygonal recess 511.

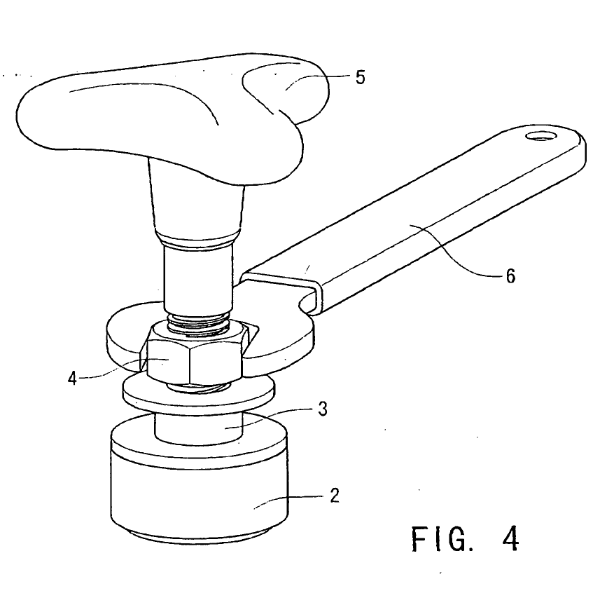

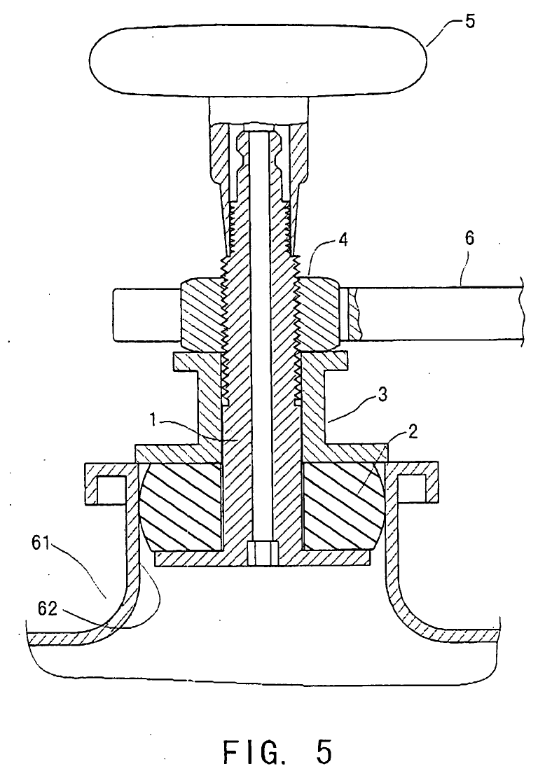

Referring to FIGS. 4 and 5, when inspecting the radiator 6, the expandable member 2, the movable member 3 and the rotatable member 4 are mounted to the cylindrical hollow part 11, and the handle 5 is connected to the polygonal first connection section 16. The expandable member 2 is inserted into the opening 62 of the radiator 61, and a wrench 6 is engaged with the rotatable member 4. The user holds the handle 5 by one hand and operates the wrench 6 by the other hand, the rotatable member 4 is lowered by the operation of the wrench 6 to compress the expandable member 2 which is expanded outward to seal the inner periphery of the opening 62. It is noted that the handle 5 positions the cylindrical hollow part 11 when rotating the rotatable member 4 so that the cylindrical hollow rotatable part 11 is not rotated with the rotatable member 4. The length of the arm of force between the wrench 6 and the body 1 is long enough so that the user can operate the wrench with less effort. The handle 5 can be easily connected with the cylindrical hollow part 11 by the polygonal recess 511 so as to reduce the assembly time.

While we have shown and described the embodiment in accordance with the present invention, it should be clear to those skilled in the art that further embodiments may be made without departing from the scope of the present invention.

What is claimed is:

1. A connection device comprising:
a body including a cylindrical hollow part which includes a first end and a first stop part on a second end of the cylindrical hollow part, a tubular body between the first and second ends, a passage defined axially through the tubular body and enclosed by an inner periphery of the passage, a connection end located on the first end of the cylindrical hollow part, the tubular body having an outer periphery and a threaded section defined in the outer periphery and close to the first end, a smooth section defined between the threaded section and the second end of the cylindrical hollow part, a polygonal first connection section located between the threaded section and the connection end, the polygonal first connection section having at least one first surface;
an expandable member having a through hole defined by an inner surface and an outer periphery, the cylindrical hollow part extending through the through hole and the inner surface being in contact with the outer periphery of the cylindrical hollow part, one of two end surfaces of the expandable member contacting the first stop part;
a movable member mounted on the outer periphery of the cylindrical hollow part and including a first flange and a second flange which is in contact with the other end surface of the expandable member;
a rotatable member threadedly connected with the threaded section of the cylindrical hollow part, the rotatable member having driving surfaces and a second stop part which is in contact with the first flange of the movable member, and
a handle having a polygonal second connection section which includes a polygonal recess having at least one second surface which is matched with the at least one first surface, the polygonal first connection section engaged with the polygonal recess.
